(19) United States
(12) Patent Application Publication
(10) Pub. No.: US 2014/0313951 A1
(43) Pub. Date: Oct. 23, 2014

(54) PHYSICAL-LAYER CONTROL CHANNEL STRUCTURE

(71) Applicant: QUALCOMM Incorporated, San Diego, CA (US)

(72) Inventors: Nicola Varanese, Nuremberg (DE); Christian Pietsch, Nuremberg (DE); Juan Montojo, Nuremberg (DE)

(73) Assignee: QUALCOMM Incorporated, San Diego, CA (US)

(21) Appl. No.: 14/229,374

(22) Filed: Mar. 28, 2014

Related U.S. Application Data
(60) Provisional application No. 61/813,036, filed on Apr. 17, 2013.

(51) Int. Cl. H04L 1/00; H04L 5/22

(52) U.S. Cl. CPC H04L 1/0075; H04L 5/22
USPC 370/294; 370/474

(57) ABSTRACT

A coax network unit (CNU) coupled to a coax line terminal (CLT) receives a plurality of orthogonal frequency-division multiplexing (OFDM) symbols from the CLT and identifies a start-of-frame delimiter on a physical-layer (PHY) control channel in the plurality of OFDM symbols. The PHY control channel includes a plurality of contiguous subcarriers. The CNU decodes one or more forward error correction (FEC) code words that follow the start-of-frame delimiter on the PHY control channel. The one or more FEC code words provide PHY control data that include information specifying a structure of a PHY frame that includes the plurality of OFDM symbols.

### RELATED APPLICATION

This application claims priority to U.S. Provisional Patent Application No. 61/813,036, titled “PHY Link Channel Structure,” filed Apr. 17, 2013, which is hereby incorporated by reference in its entirety.

### TECHNICAL FIELD

The present embodiments relate generally to communication systems, and specifically to frame structure in communications using orthogonal frequency-division multiplexing (OFDM) or similar techniques.

### BACKGROUND OF RELATED ART

The Ethernet Passive Optical Networks (EPON) protocol may be extended over coaxial (coax) links in a cable plant. The EPON protocol as implemented over coax links is called EPON Protocol over Coax (EPoC). Implementing an EPoC network or similar network over a cable plant presents significant challenges. For example, there is a need for efficient techniques to communicate information regarding channel structure and frame structure between a coax line terminal and coax network units.

### SUMMARY

Embodiments are disclosed in which a physical-layer (PHY) control channel that includes a plurality of contiguous subcarriers is used to communicate PHY control data between a coax line terminal (CLT) and coax network units (CNUs).

In some embodiments, a method of data communication is performed at a CNU coupled to a CLT. The CNU receives a plurality of OFDM symbols from the CLT and identifies a start-of-frame delimiter on a PHY control channel in the plurality of OFDM symbols. The PHY control channel includes a plurality of contiguous subcarriers. The CNU decodes one or more forward error correction (FEC) code words that follow the start-of-frame delimiter on the PHY control channel. The one or more FEC code words provide PHY control data that include information specifying a structure of a PHY frame that includes the plurality of OFDM symbols.

In some embodiments, a CNU includes a receiver to receive a plurality of OFDM symbols and identify a start-of-frame delimiter on a PHY control channel in the plurality of OFDM symbols. The PHY control channel includes a plurality of contiguous subcarriers. The CNU is also configured to decode one or more FEC code words that follow the start-of-frame delimiter on the PHY control channel. The one or more FEC code words provide PHY control data that include information specifying a structure of a PHY frame that includes the plurality of OFDM symbols.

In some embodiments, a method of data communication is performed at a CLT coupled to a plurality of CNUs. The CLT transmits a plurality of OFDM symbols to the plurality of CNUs. To transmit the plurality of OFDM symbols, the CLT places a start-of-frame delimiter on a PHY control channel in the plurality of OFDM symbols. The PHY control channel includes a plurality of contiguous subcarriers. The CNU also places one or more FEC code words on the PHY control channel following the start-of-frame delimiter. The one or more FEC code words provide PHY control data that include information specifying a structure of a PHY frame that includes the plurality of OFDM symbols.

In some embodiments, a CLT includes a transmitter to transmit a plurality of OFDM symbols. The transmitter is configured to place a start-of-frame delimiter on a PHY control channel in the plurality of OFDM symbols. The PHY control channel includes a plurality of contiguous subcarriers. The transmitter is further configured to place one or more FEC code words on the PHY control channel following the start-of-frame delimiter. The one or more FEC code words provide PHY control data that include information specifying a structure of a PHY frame that includes the plurality of OFDM symbols.

### BRIEF DESCRIPTION OF THE DRAWINGS

The present embodiments are illustrated by way of example and are not intended to be limited by the figures of the accompanying drawings.

FIG. 1A is a block diagram of a coaxial network in accordance with some embodiments.

FIG. 1B is a block diagram of a network that includes both optical links and coax links in accordance with some embodiments.

FIG. 2 is a block diagram of a system in which a coax line terminal is coupled to a coax network unit in accordance with some embodiments.

FIG. 3 shows a sequence of physical-layer frames used for frequency-division duplexing in accordance with some embodiments.

FIGS. 4A-4D show physical-layer frames used for frequency-division duplexing in accordance with some embodiments.

FIG. 5 shows a physical-layer frame that includes a physical-layer link channel and also includes continual pilot symbols that may be used to identify the start and end of downstream windows, in accordance with some embodiments.

FIG. 6 is a flowchart show a method of data communication between a coax line terminal and a coax network unit in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

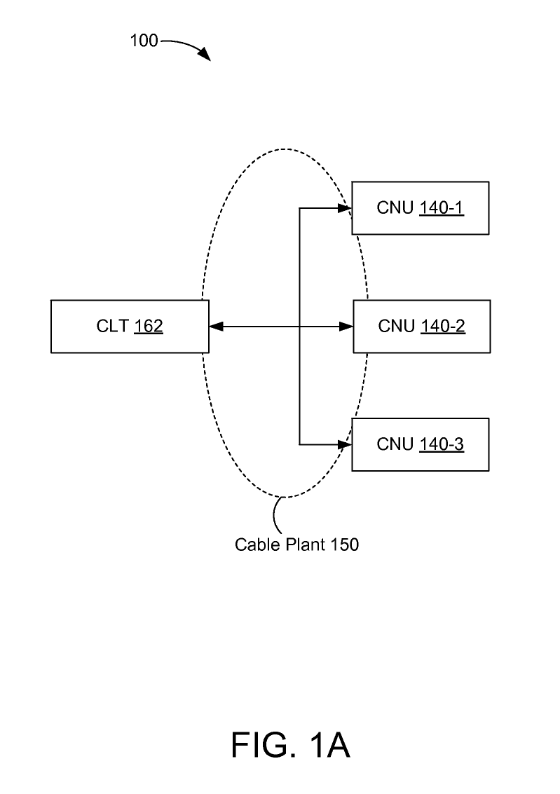

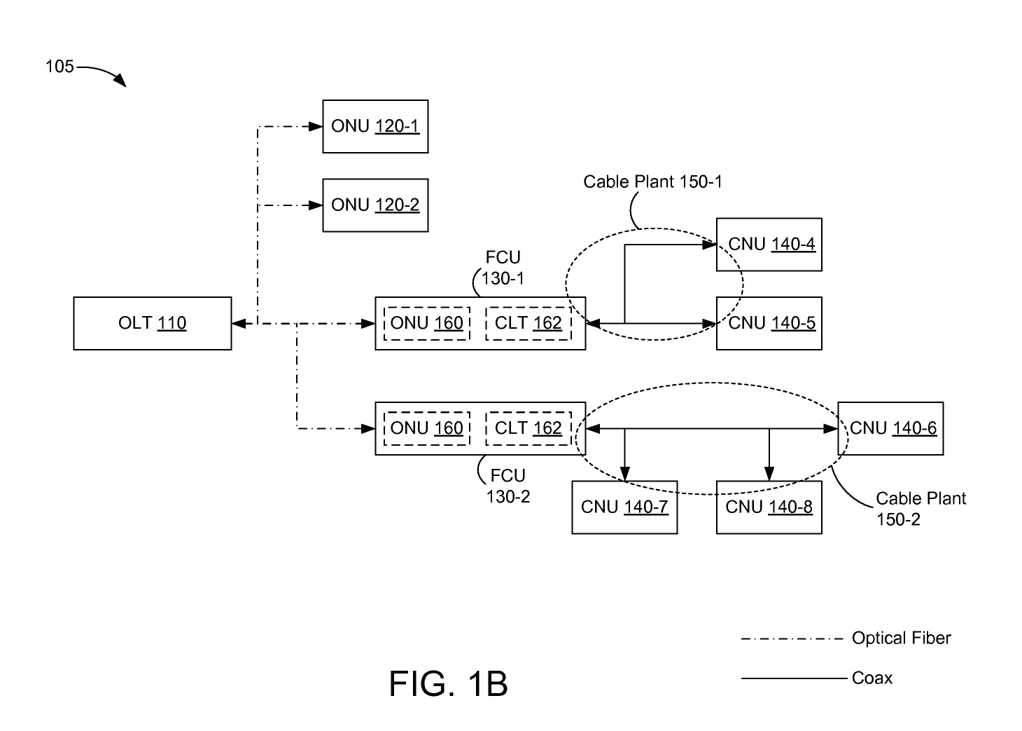

FIG. 1A is a block diagram of a coax network 100 (e.g., an EPoC network) in accordance with some embodiments. The network 100 includes a coax line terminal (CLT) 162 (also referred to as a coax link terminal) coupled to a plurality of coax network units (CNUs) 140-1, 140-2, and 140-3 via coax links. A respective coax link may be a passive coax cable, or may also include one or more amplifiers and/or equalizers, and may run through one or more splitters and/or taps. The coax links compose a cable plant 150. In some embodiments, the CLT 162 is located at the headend of the cable plant 150 and the CNUs 140 are located at the premises of respective users. Alternatively, the CLT 162 is located within the cable plant 150.

The CLT 162 transmits downstream signals to the CNUs 140-1, 140-2, and 140-3 and receives upstream signals from the CNUs 140-1, 140-2, and 140-3. In some embodiments, each CNU 140 receives every packet transmitted by the CLT 162 and discards packets that are not addressed to it. The CNUs 140-1, 140-2, and 140-3 transmit upstream signals using coax resources specified by the CLT 162. For example, the CLT 162 transmits control messages (e.g., GATE messages) to the CNUs 140-1, 140-2, and 140-3 specifying respective future times at which and respective frequencies on which respective CNUs 140 may transmit upstream signals. The bandwidth allocated to a respective CNU by a control message may be referred to as a grant. In some embodiments, the downstream and upstream signals are transmitted using orthogonal frequency-division multiplexing (OFDM). For example, the upstream signals are orthogonal frequency-division multiple access (OFDMA) signals and the downstream signals include modulation symbols on different groups of subcarriers that are directed to different CNUs 140.

In some embodiments, the CLT 162 is part of a fiber-coax unit (FCU) 130 that is also coupled to an optical line terminal (OLT) 110, as shown in FIG. 1B. FIG. 1B is a block diagram of a network 105 that includes both optical links and coax links in accordance with some embodiments. In the network 105, the OLT 110 (also referred to as an optical link terminal) is coupled to a plurality of optical network units (ONUs) 120-1 and 120-2 via respective optical fiber links. The OLT 110 also is coupled to a plurality of fiber-coax units (FCUs) 130-1 and 130-2 via respective optical fiber links. FCUs are also referred to as optical-coax units (OCUs).

In some embodiments, each FCU 130-1 and 130-2 includes an ONU 160 coupled with a CLT 162. The ONU 160 receives downstream packet transmissions from the OLT 110 and provides them to the CLT 162, which forwards the packets to the CNUs 140 (e.g., CNUs 140-4 and 140-5, or CNUs 140-6 through 140-8) on its cable plant 150 (e.g., cable plant 150-1 or 150-2). In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1B, the first FCU 130-1 communicates with CNUs 140-4 and 140-5 (e.g., using OFDMA), and the second FCU 130-2 communicates with CNUs 140-6, 140-7, and 140-8 (e.g., using OFDMA). The coax links coupling the first FCU 130-1 with CNUs 140-4 and 140-5 compose a first cable plant 150-1. The coax links coupling the second FCU 130-2 with CNUs 140-6 through 140-8 compose a second cable plant 150-2. A respective coax link may be a passive coax cable, or alternately may include one or more amplifiers and/or equalizers, and may run through one or more splitters and/or taps. In some embodiments, the OLT 110, ONUs 120-1 and 120-2, and optical portions of the FCUs 130-1 and 130-2 are implemented in accordance with the Ethernet Passive Optical Network (EPON) protocol.

In some embodiments, the OLT 110 is located at a network operator's headend, the ONUs 120 and CNUs 140 are located at the premises of respective users, and the FCUs 130 are located at the headends of their respective cable plants 150 or within their respective cable plants 150.

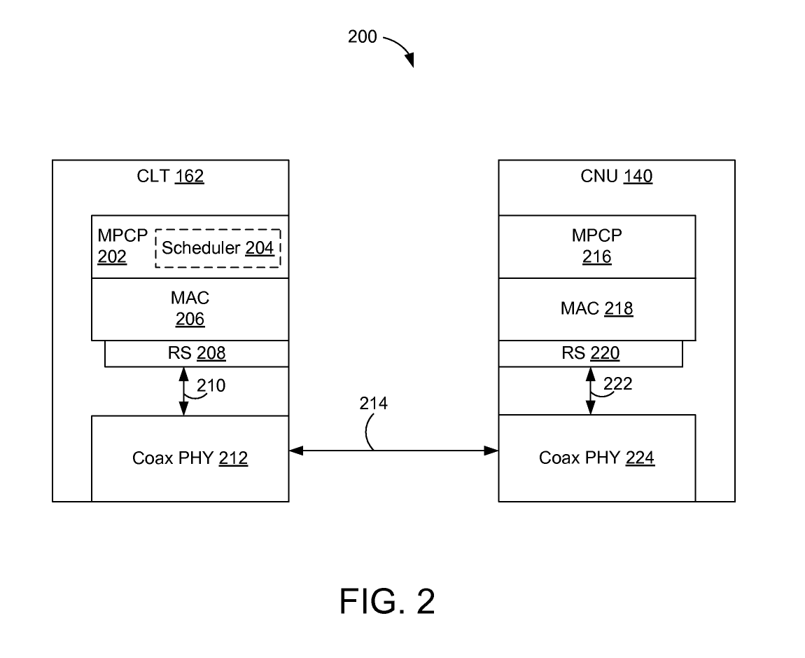

FIG. 2 is a block diagram of a system 200 in which a CLT 162 is coupled to a CNU 140 (e.g., one of the CNUs 140-1 through 140-8, FIGS. 1A-1B) by a coax link 214 (e.g., in a cable plant 150, such as the cable plant 150-1 or 150-2, FIGS. 1A-1B) in accordance with some embodiments. The CLT 162 and CNU 140 communicate via the coax link 214. The coax link 214 couples a coax physical layer (PHY) 212 in the CLT 162 to a coax PHY 224 in the CNU 140.

The coax PHY 212 in the CLT 162 is coupled to a media access controller (MAC) 206 (e.g., a full-duplex MAC) by a media-independent interface 210 and a reconciliation sublayer (RS) 208. In some embodiments, the media-independent interface 210 is a 10-Gigabit Media-Independent Interface (XGMII). The MAC 206 is coupled to a multi-point control protocol (MPCP) implementation 202, which includes a scheduler 204 that schedules downstream and upstream transmissions.

The coax PHY 224 in the CNU 140 is coupled to a MAC 218 (e.g., a full-duplex MAC) by a media-independent interface 222 (e.g., an XGMII) and an RS 220. The MAC 218 is coupled to an MPCP implementation 216 that communicates with the MPCP implementation 202 to schedule upstream transmissions (e.g., by sending REPORT messages to the MPCP 202 implementation and receiving GATE messages in response).

In some embodiments, the MPCP implementations 202 and 216 are implemented as distinct sub-layers in the respective protocol stacks of the CLT 162 and CNU 140. In other embodiments, the MPCP implementations 202 and 216 are respectively implemented in the same layers or sub-layers as the MACs 206 and 218.

Communication between a CLT 162 and respective CNUs 140 on a cable plant 150 may be performed using frequency-division duplexing (FDD) or time-division duplexing (TDD). For FDD, upstream and downstream transmissions use different frequency bands and therefore may be simultaneous. For TDD, upstream and downstream transmissions share one or more frequency bands, with upstream transmissions occurring at different times (e.g., in different time windows) than downstream transmissions.

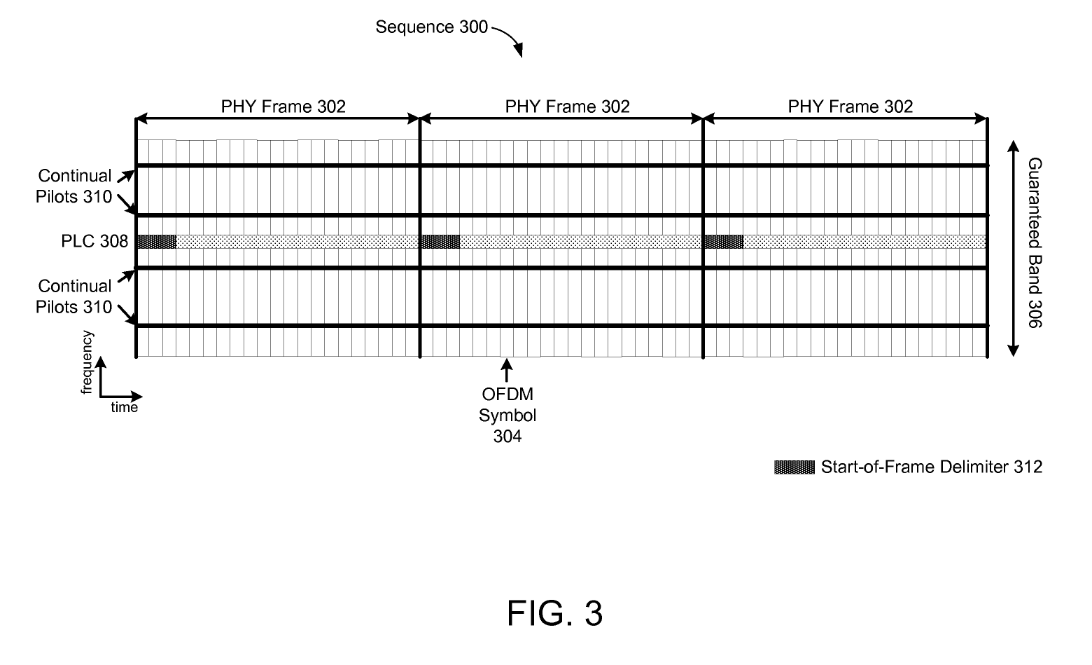

FIG. 3 shows a sequence 300 of physical-layer (PHY) frames 302 used for FDD (e.g., for downstream transmissions) in accordance with some embodiments. Each PHY frame 302 includes a plurality of OFDM symbols 304. (Each column in FIG. 3 corresponds to a distinct OFDM symbol 304.) Each OFDM symbol 304 includes a plurality of modulation symbols on respective subcarriers.

In some embodiments, the channel on which the PHY frames 302 are transmitted includes a minimum guaranteed continuous frequency band 306 (a “guaranteed band 306”). There are no exclusion bands within the guaranteed band 306. However, some subcarriers within the guaranteed band 306 may not be used for data transmission. Alternatively, there are no nulled subcarriers within the guaranteed band 306 in accordance with some embodiments. Examples of the width of the guaranteed band 306 include, but are not limited to, 6 MHz, 12 MHz, and 24 MHz. While the location of the guaranteed band 306 in the available frequency spectrum remains fixed with respect to a sequence 300 of PHY frames 302, it may change over time (e.g., it may be changed periodically).

The PHY frames 302 include a PHY link channel (PLC) 308. The PHY link channel 308 is an example of a PHY control channel. A specified number of subcarriers may be reserved for the PHY link channel 308. The number of subcarriers in the PHY link channel 308 is thus predefined. In one example, the PHY link channel 308 includes eight subcarriers. In some embodiments, the PHY link channel 308 is at the center of the guaranteed band 306. The PHY link channel 308 may be used to communicate PHY control data between a transmitter (e.g., in the coax PHY 212 of a CLT 162, FIG. 2) and a receiver (e.g., in the coax PHY 224 of a CNU 140, FIG. 2). Examples of PHY control data may include, but are not limited to, data for an auto-negotiation procedure, OFDM channel identifiers, available bandwidth (e.g., downstream bandwidth), specification of exclusion bands, specification of PHY frame structure for TDD or upstream FDD, active profiles and corresponding modulation and coding schemes (MCSs), profile assignments, time interleaving depth, timing advance information, and/or power control information. The PHY link channel 308 may be used both during registration and regular operation.

The PHY frames 302 may also include continual pilot symbols 310 on one or more subcarriers. The continual pilot symbols 310 are known modulation symbols. In some embodiments, one or more pairs of continual pilot symbols 310 are placed symmetrically about the PHY link channel 308. Each such pair thus has mirror symmetry about the PHY link channel 308. Two such pairs of continual pilot symbols 310 are shown in FIG. 3. Such a configuration allows the location of the PHY link channel 308 to be determined based on the locations of the continual pilot symbols 310 (e.g., by averaging the indices of a symmetric pair of continual pilot symbols 310).

The continual pilot symbols 310 are said to be continual because they are present on their respective subcarriers in each OFDM symbol 304 of each PHY frame 302. PHY frames 302 may also include non-continual pilot symbols on specified subcarriers. For example, two OFDM symbols 304 (e.g., the first and second OFDM symbols 304) of a respective PHY frame 302 may include additional pilot symbols on a specified set of subcarriers (e.g., on every subcarrier or every other subcarrier).

The PHY link channel 308 may include a start-of-frame delimiter 312, which is also referred to as a preamble, at the beginning of respective PHY frames 302 (e.g., the beginning of each PHY frame 302). The start-of-frame delimiter 312 is used to identify the beginning of the respective PHY frames 302. The start-of-frame delimiter 312 includes known modulation symbols placed on subcarriers in the PHY link channel 308 in a specified number of OFDM symbols 304 (e.g., three OFDM symbols 304, as shown in FIG. 3) at the beginning of the PHY frame 302. The start-of-frame delimiter 312 allows PHY frame synchronization at the receiver.

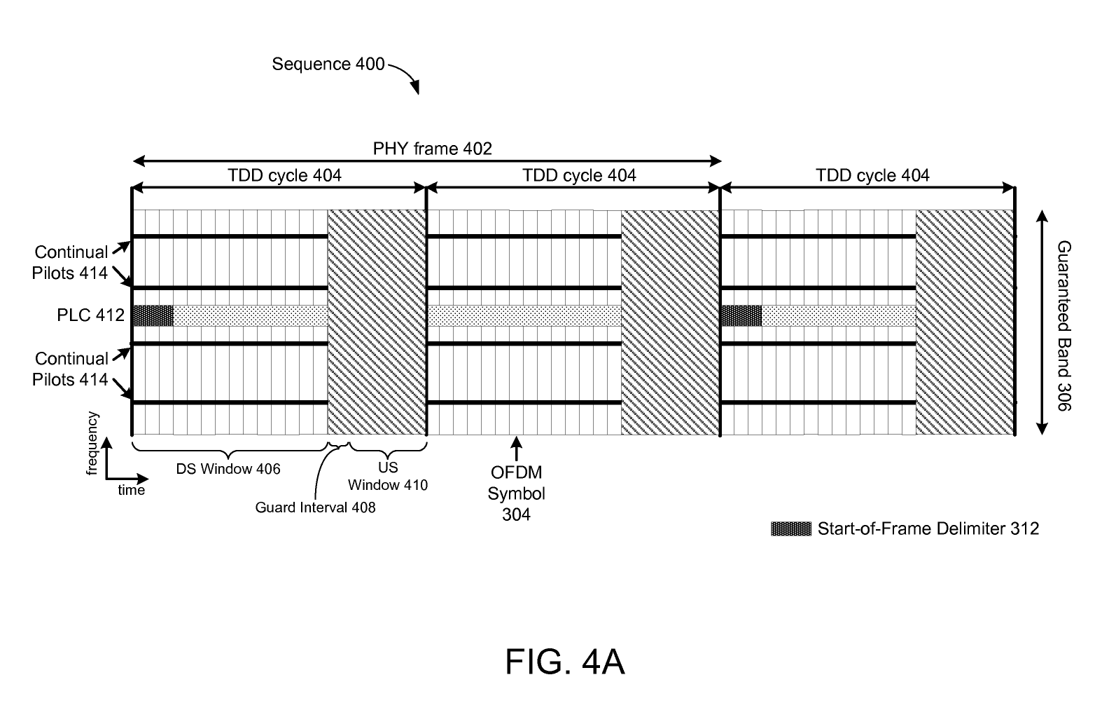

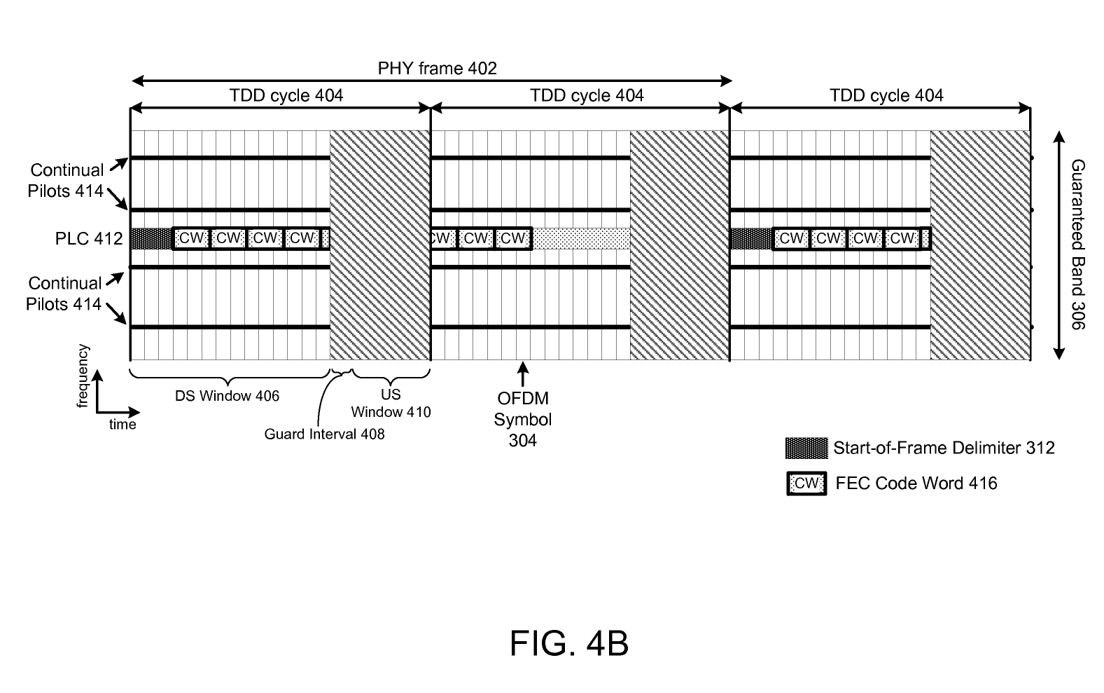

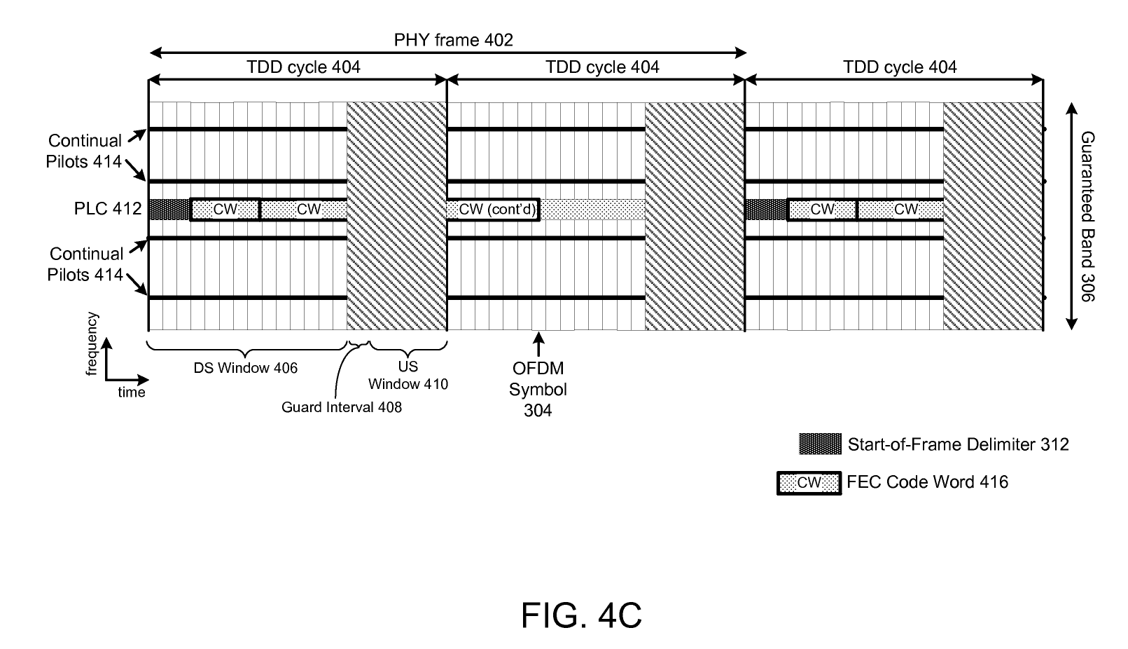

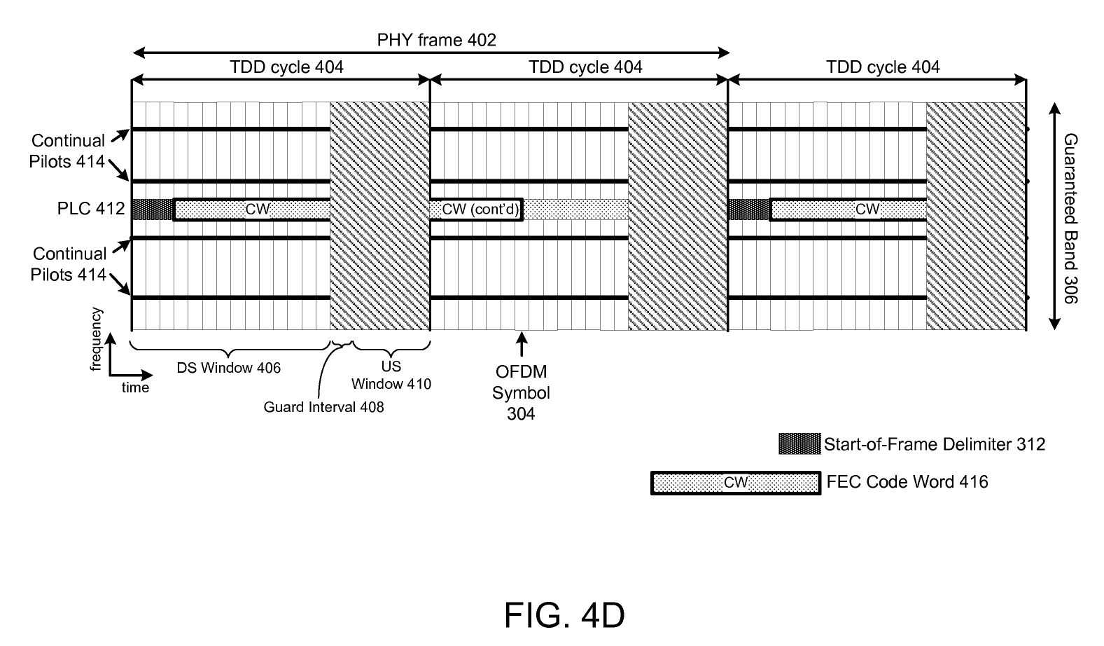

FIG. 4A shows a sequence 400 of TDD cycles 404 in accordance with some embodiments. A PHY frame 402 extends across two TDD cycles 404. (More generally, a PHY frame 402 may span one or more TDD cycles 404.) Each TDD cycle 404 includes a downstream (DS) time window 406 (or downstream window 406 for short), an upstream (US) window 410 (or upstream window 410 for short), and a guard interval 408. A CLT 162 may transmit downstream to respective CNUs 140 on a cable plant 150 during downstream windows 406 but not during upstream windows 410 and guard intervals 408. The CLT 162 may receive upstream transmissions from respective CNUs 140 (e.g., in accordance with GATE messages provided by the CLT 162) during upstream windows 410 but not during downstream windows 406 and guard intervals 408.

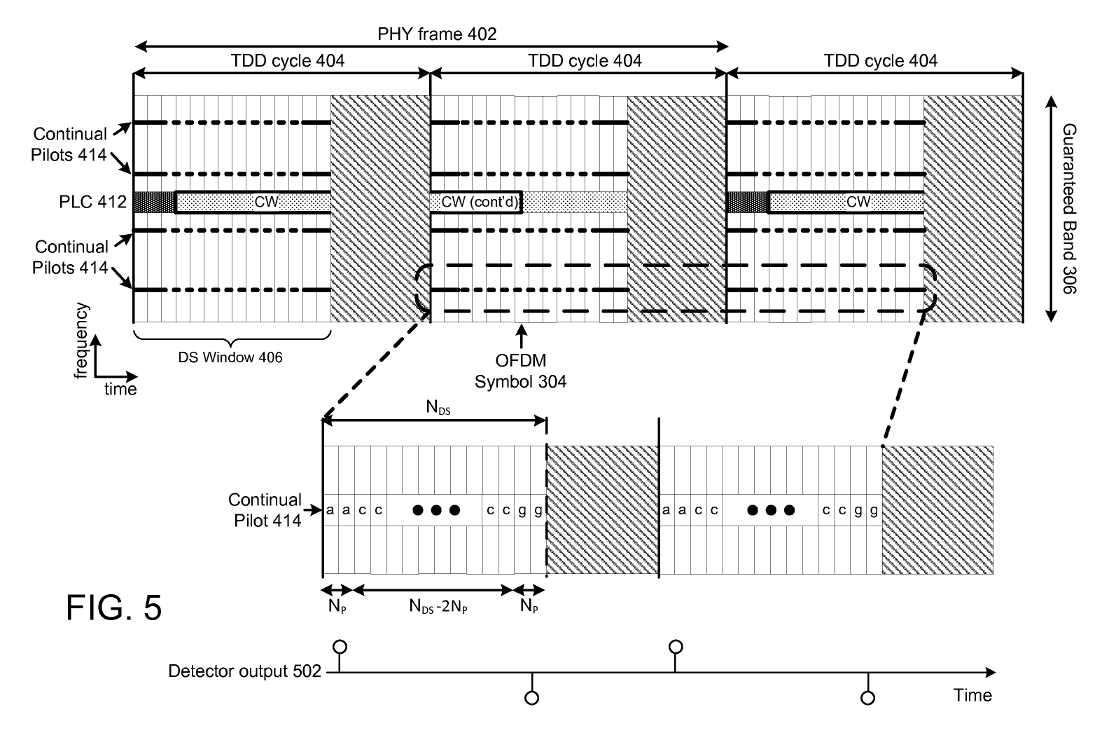

The downstream windows 406 in a PHY frame 402 include a specified number of OFDM symbols 304. (Each column in each downstream window 406 of FIGS. 4A-4D and 5 corresponds to a distinct OFDM symbol 304 transmitted, for example, by a CLT 162.)

Continual pilot symbols 414 may be included in the downstream windows 406. In the context of TDD, pilot symbols are said to be continual if they are present on their respective subcarriers in each OFDM symbol 304 of the downstream windows 406. One or more respective pairs of continual pilot symbols 414 may be symmetric about a PHY link channel 412. The PHY link channel 412 is another example of a PHY control channel.

The PHY link channel 412 includes a specified number of subcarriers (e.g., eight subcarriers) in the downstream windows 406. As described for the PHY link channel 308 (FIG. 3), the PHY link channel 412 may be at the center of the guaranteed band 306 and may include respective start-of-frame delimiters 312 at the beginning of respective PHY frames 402. Start-of-frame delimiters 312 are thus included at the beginning of the first TDD cycle 404 in respective PHY frames 402 and repeat every N downstream OFDM symbols 304, where N is the number of downstream OFDM symbols 304 in a PHY frame 402. The start-of-frame delimiters 312 may be used in the receiver (e.g., in a coax PHY 224 of a CNU 140, FIG. 2) for PHY frame synchronization and for TDD cycle alignment. Information provided via the PHY link channel 412 may include TDD cycle duration, upstream and downstream window durations, and guard interval durations. For example, the CLT 162 uses the PHY link channel 412 to provide this information to CNUs 140. In some embodiments, the data in the PHY link channel 412 repeats from PHY frame 402 to PHY frame 402, and thus repeats every N downstream OFDM symbols 304.

In some embodiments, information conveyed by the PHY link channel 412 is encoded into forward error correction (FEC) code words (CWs) 416. FIG. 4B shows an example in which multiple code words 416 are transmitted on the PHY link channel 412 during a PHY frame 402. In the example of FIG. 4B, a first group of code words 416 is transmitted on the PHY link channel 412 during a first TDD cycle 404 of a PHY frame 402 and a second group of code words 416 is transmitted on the PHY link channel 412 during a second TDD cycle 404 of the PHY frame 402. Also, a code word 416 is split between the first and second TDD cycles 404 of the PHY frame 402. A code word 416 in the first group (e.g., the first code word 416 following the start-of-frame delimiter 312) includes information specifying the TDD cycle structure and may include additional information regarding the channel and PHY frame structure. In some embodiments, the information specifying the TDD cycle structure is the first information sent on the PHY link channel 412 following the start-of-frame delimiter 312. In some embodiments, information specifying the TDD cycle structure, PHY frame structure, exclusion bands, and/or active modulation profiles (e.g., corresponding to respective modulation and coding schemes) is included in a specified number of code words 416 at the beginning of the payload on the PHY link channel 412 within a PHY frame 402 (e.g., within a first TDD cycle 404 of the PHY frame 402).

In some embodiments, a first code word 416 conveyed on the PHY link channel 412 in a PHY frame 402 is followed by a longer second code word 416, as shown in FIG. 4C in accordance with some embodiments. The first code word 416, which is transmitted during the first downstream window 406 (and thus the first TDD cycle 404) of the PHY frame 402, includes information specifying the TDD cycle structure and may include additional information regarding the channel and PHY frame structure. The longer second code word 416 may extend into the second downstream window 406 (and thus the second TDD cycle 404 of the PHY frame 402), as FIG. 4C shows.

In some embodiments, a respective PHY frame 402 includes a single FEC code word 416 that extends across multiple TDD cycles 404 (or portions thereof), as shown in FIG. 4D in accordance with some embodiments. The start-of-frame delimiter 312 in the PHY frame 402 of FIG. 4D is followed by a code word 416 that extends across the remainder of the first downstream window 406 in the first TDD cycle 404 of the PHY frame 402 and into the second downstream window 406 in the second TDD cycle 404 of the PHY frame 402. The long code word 416 of FIG. 4D allows the use of efficient FEC encoding. However, because the long code word 416 of FIG. 4D extends into the second TDD cycle 404, it does not provide the receiver (e.g., the coax PHY 224 of a CNU 140, FIG. 2) with the TDD cycle structure before the end of the first TDD cycle 404.

FIG. 5 shows a PHY frame 402 that includes the long code word 416 of FIG. 4D and also includes continual pilot symbols 414 that may be used to identify the start and end of each downstream window 406, in accordance with some embodiments. The continual pilot symbols 414 have a modulation pattern that notifies the receiver of the TDD cycle structure. In some embodiments, a respective subcarrier used for continual pilot symbols 414 includes a first predefined pilot symbol (“a”) on a specified number N_{P} of OFDM symbols 304 at the beginning of each downstream window 406 and a second predefined pilot symbol (“g”) on a specified number N_{P} of OFDM symbols 304 at the end of each downstream window 406. In the example of FIG. 4D, the first predefined pilot symbol (“a”) is present in the first two OFDM symbols 304 of the downstream window 406 and the second predefined pilot symbol (“g”) is present in the last two OFDM symbols 304 of the downstream window 406. In other examples, the first and/or second predefined pilot symbols are present on one OFDM symbol 304 at the corresponding edge of the downstream window 406 or on more than two OFDM symbols 304 at the corresponding edge of the downstream window 406. A third predefined pilot symbol (“c”) may be used for the continual pilot symbols in the OFDM symbols 304 in the middle of the downstream window 406 (e.g., on the N_{DS}−2N_{P} OFDM symbols 304 in the middle of the downstream window 406, where N_{DS} is the number of OFDM symbols 304 in the downstream window 406). In some embodiments, the same pilot symbols are used for all of the subcarriers that carry continual pilot symbols 414. Alternatively, different pilot symbols are used on different subcarriers carrying respective continual pilot symbols 414.

In the example of FIG. 5, a=+1, c=−1, and g=+1. A detector in the receiver (e.g., in the coax PHY 224 of a CNU 140, FIG. 2) generates detector output 502, which identifies the start and end of the downstream windows 406. For example, a positive detector output 502 indicates the start of a downstream window 406 and a negative detector output indicates the end of a downstream window 406. In some embodiments, the detector identifies the start and end of the downstream windows 406 by looking at the phase difference between successive continual pilot symbols 414. For example, the detector identifies sign flips in the values of successive continual pilot symbols 414.

Attention is now directed to an initial acquisition sequence in accordance with some embodiments. This sequence may be performed by a CNU 140 (FIG. 2). The sequence begins with determination of the Fast Fourier Transform (FFT) size and cyclic prefix (CP) size, using correlation. OFDM symbol synchronization is then performed to find the FFT boundaries. Next, the fractional frequency offset between the transmitter (e.g., in the coax PHY 212, FIG. 2) and receiver (e.g., in the coax PHY 224, FIG. 2) is determined. The continual pilot symbols (e.g., continual pilot symbols 310, FIG. 3, or 414, FIGS. 4A-4D and 5) are then identified. Based on the continual pilot symbols, integer frequency offset between the transmitter and receiver is identified. For TDD, phase jumps are identified in the continual pilot symbols 414 to detect the start and end of downstream windows 406, as described with respect to FIG. 5. The start-of-frame delimiter 312 is detected, and a channel estimate is made using the start-of-frame delimiter 312.

Data from the PHY control channel (e.g., PLC 308, FIG. 3; PLC 412, FIGS. 4A-4D and 5), as transmitted by a CLT 162, is then decoded to obtain OFDM channel parameters. Examples of OFDM channel parameters may include, but are not limited to, the center frequency, the available subcarriers, FEC and/or interleaving pointers, active profiles, and pilot symbols.

An admission process is performed to register the CNU 140 with the CLT 162. Ranging (e.g., including round-trip time measurement) is performed to determine a timing advance for the CNU 140. Finally, the CNU 140 begins to transmit data to the CLT 162.

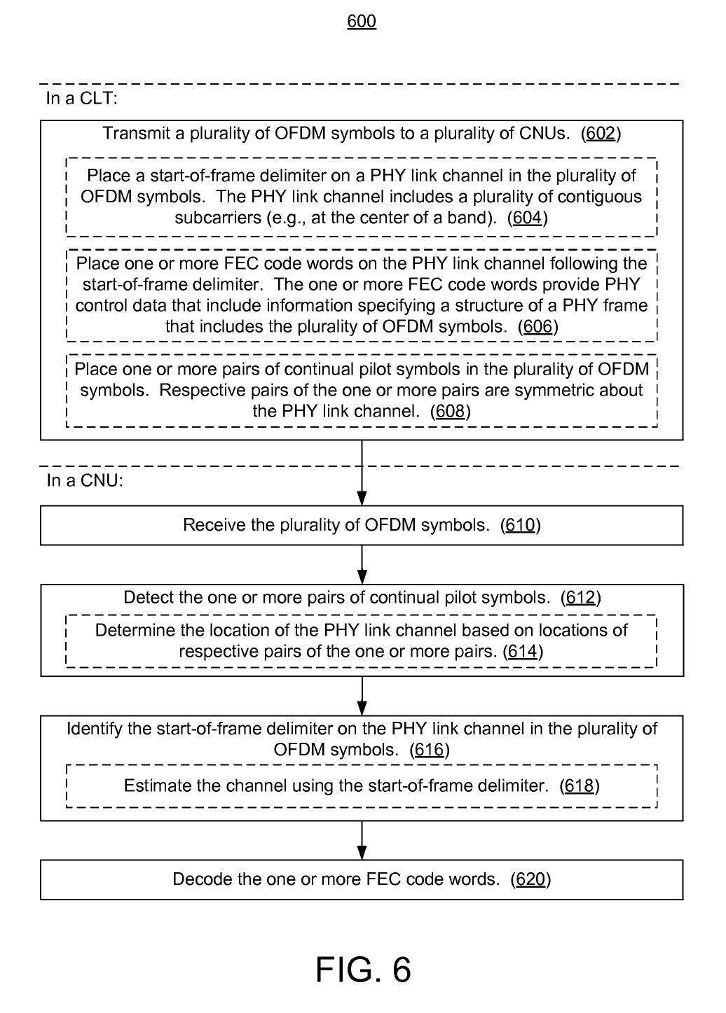

FIG. 6 is a flowchart show a method 600 of data communication between a CLT 162 and a CNU 140 in accordance with some embodiments. The CLT 162 transmits (602) a plurality of OFDM symbols 304 to a plurality of CNUs 140. As part of transmitting the plurality of OFDM symbols 304, a start-of-frame delimiter 312 is placed (604) on a PHY control channel in the plurality of OFDM symbols 304. The PHY control channel (e.g., PLC 308, FIG. 3; PLC 412, FIGS. 4A-4D and 5) includes a plurality of contiguous subcarriers. In some embodiments, the contiguous subcarriers of the PHY control channel are at the center of a band (e.g., a guaranteed band 306, which has no exclusion bands). Also, one or more FEC code words 416 are placed (606) on the PHY control channel following the start-of-frame delimiter 312. The one or more FEC code words 416 provide PHY control data that include information specifying a structure of a PHY frame (e.g., PHY frame 302, FIG. 3; PHY frame 402, FIGS. 4A-4D and 5) that includes the plurality of OFDM symbols 304. Furthermore, in some embodiments one or more pairs of continual pilot symbols (e.g., continual pilot symbols 310, FIG. 3; continual pilot symbols 414, FIGS. 4A-4D and 5) are placed (608) in the plurality of OFDM symbols 304, such that respective pairs of the one or more pairs of continual pilot symbols are symmetric about the PHY control channel.

In some embodiments, the plurality of OFDM symbols 304 is transmitted during downstream windows 406 in respective TDD cycles 404 (FIGS. 4A-4D and 5). Alternatively, the plurality of OFDM symbols is transmitted using FDD (e.g., as shown in FIG. 3).

In some embodiments, a plurality of FEC code words 416 is placed on the PHY control channel following the start-of-frame delimiter in operation 606. The plurality of FEC code words 416 includes an initial FEC code word 416 (e.g., as shown in FIG. 4C) following the start-of-frame delimiter 312 that specifies the structure of a TDD cycle 404. For example, the initial FEC code word 416 specifies a duration of the TDD cycle 404, a duration of an upstream window 410, a duration of a downstream window 406, and/or a duration of a guard interval 408. In some embodiments, the plurality of FEC code words 416 includes a second FEC code word 416 following the initial FEC code word 416 and having a longer duration than the initial FEC code word 416 (e.g., as shown in FIG. 4C).

In some embodiments, the PHY frame that includes the plurality of OFDM symbols 304 transmitted in operation 602 includes a first TDD cycle 404 and a second, following TDD cycle 404. A plurality of FEC code words 416 is placed on the PHY control channel following the start-of-frame delimiter 312 in operation 606. The plurality of FEC code words 416 includes a first group of FEC code words 416 on the PHY control channel in the first TDD cycle 404 and a second group of FEC code words 416 on the PHY control channel in the second TDD cycle 404 (e.g., as shown in FIG. 4B). The plurality of FEC code words 416 may further include an FEC code word 416 split between the first TDD cycle 404 and the second TDD cycle 404 on the PHY control channel (e.g., as shown in FIG. 4B). A respective FEC code word 416 of the first group specifies the TDD cycle structure (e.g., including a duration of the TDD cycle 404, a duration of an upstream window 410, a duration of a downstream window 406, and/or a duration of a guard interval 408).

A CNU 140 receives (610) the plurality of OFDM symbols 304. For example, the OFDM symbols 304 are received in the downstream windows 406 in respective TDD cycles 404 (FIGS. 4A-4D and 5) or using FDD (e.g., as shown in FIG. 3).

In some embodiments, the CNU 140 detects (612) the one or more pairs of continual pilot symbols (e.g., continual pilot symbols 310, FIG. 3; continual pilot symbols 414, FIGS. 4A-4D and 5) and determines (614) the location of the PHY control channel (e.g., PLC 308, FIG. 3; PLC 412, FIGS. 4A-4D and 5) based on locations of respective pairs of the one or more pairs. The CNU 140 may identify the beginnings and ends of downstream windows 406 based on continual pilot symbols 414 (e.g., as described with respect to FIG. 5). For example, the CNU 140 may use the continual pilot symbols 414 to identify the beginnings and ends of downstream windows 406 in embodiments in which a code word 416 spans at least portions of multiple TDD cycles 404 (e.g., as shown in FIGS. 4D and 5).

The CNU 140 identifies (616) the start-of-frame delimiter 312 on the PHY control channel in the plurality of OFDM symbols. The CNU 140 may use the start-of-frame delimiter 312 to estimate (618) the channel. The start-of-frame delimiter 312 may also be used for PHY frame synchronization and TDD cycle alignment.

The CNU 140 decodes (620) the one or more FEC code words 416. PHY control data is extracted from the one or more FEC code words 416 and used to facilitate communications with the CLT 162.

The method 600 includes a number of operations that appear to occur in a specific order. It should be apparent, however, that the method 600 can include more or fewer operations, which can be executed serially or in parallel. An order of two or more operations may be changed, performance of two or more operations may overlap, and two or more operations may be combined into a single operation.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of data communication, comprising:
at a coax network unit (CNU) coupled to a coax line terminal (CLT):
receiving a plurality of orthogonal frequency-division multiplexing (OFDM) symbols;
identifying a start-of-frame delimiter on a physical-layer (PHY) control channel in the plurality of OFDM symbols, the PHY control channel comprising a plurality of contiguous subcarriers; and
decoding one or more forward error correction (FEC) code words that follow the start-of-frame delimiter on the PHY control channel, the one or more FEC code words providing PHY control data that comprise information specifying a structure of a PHY frame that includes the plurality of OFDM symbols.

2. The method of claim 1, wherein the plurality of contiguous subcarriers for the PHY control channel is at the center of a band.

3. The method of claim 2, wherein the band has no exclusion bands.

4. The method of claim 1, wherein the start-of-frame delimiter comprises modulation symbols on the plurality of contiguous subcarriers in a group of OFDM symbols at the beginning of the PHY frame.

5. The method of claim 1, further comprising, at the CNU, making a channel estimate using the start-of-frame delimiter.

6. The method of claim 1, further comprising, at the CNU:
detecting one or more pairs of continual pilot symbols in the plurality of OFDM symbols, wherein respective pairs of the one or more pairs are symmetric about the PHY control channel; and
determining a location of the PHY control channel based on locations of the respective pairs.

7. The method of claim 1, wherein the receiving comprises receiving the plurality of OFDM symbols during downstream time windows in respective time-division duplexing (TDD) cycles.

8. The method of claim 7, further comprising, at the CNU:
detecting continual pilot symbols in the plurality of OFDM symbols; and
identifying the beginnings and ends of the downstream time windows based on the continual pilot symbols.

9. The method of claim 8, wherein the one or more FEC code words comprise an FEC code word that spans at least portions of multiple TDD cycles.

10. The method of claim 8, wherein:
the continual pilot symbols comprise a first modulation symbol at beginnings of the downstream time windows, a second modulation symbol at ends of the downstream time windows, and a third modulation symbol between the first and second modulation symbols;
the first modulation symbol has a first phase;
the second modulation symbol has a second phase;
the third modulation symbol has a third phase; and
identifying the beginnings and ends of the downstream time windows comprises identifying phase changes between the first, third, and second modulation symbols.

11. The method of claim 7, wherein:
the one or more FEC code words comprise a plurality of FEC code words;
the plurality of FEC code words comprises an initial FEC code word following the start-of-frame delimiter on the PHY control channel; and
the initial FEC code word specifies a TDD cycle structure.

12. The method of claim 11, wherein the initial FEC code word specifies a TDD cycle duration, an upstream time window duration, a downstream time window duration, and a guard interval duration.

13. The method of claim 11, wherein the plurality of FEC code words comprises a second FEC code word following the initial FEC code word and having a longer duration than a duration of the initial FEC code word.

14. The method of claim 7, wherein:
the PHY frame comprises a first TDD cycle and a second TDD cycle that follows the first TDD cycle;
the one or more FEC code words comprise a plurality of FEC code words;
the plurality of FEC code words comprises a first group of FEC code words on the PHY control channel in the first TDD cycle and a second group of FEC code words on the PHY control channel in the second TDD cycle; and
the first group comprises a respective FEC code word that specifies a TDD cycle structure.

15. The method of claim 14, wherein the plurality of FEC code words further comprises an FEC code word split between the first TDD cycle and the second TDD cycle on the PHY control channel.

16. A method of data communication, comprising:
transmitting a plurality of orthogonal frequency-division multiplexing (OFDM) symbols from a coax line terminal (CLT) to a plurality of coax network units (CNUs), the transmitting comprising:
placing a start-of-frame delimiter on a physical-layer (PHY) control channel in the plurality of OFDM symbols, the PHY control channel comprising a plurality of contiguous subcarriers; and
placing one or more forward error correction (FEC) code words on the PHY control channel following the start-of-frame delimiter, the one or more FEC code words providing PHY control data that comprise information specifying a structure of a PHY frame that includes the plurality of OFDM symbols.

17. The method of claim 16, wherein the plurality of contiguous subcarriers for the PHY control channel is at the center of a band.

18. The method of claim 16, wherein the transmitting further comprises placing one or more pairs of continual pilot symbols in the plurality of OFDM symbols, wherein respective pairs of the one or more pairs are symmetric about the PHY control channel.

19. The method of claim 16, wherein:
the transmitting comprises transmitting the plurality of OFDM symbols during downstream time windows in respective time-division duplexing (TDD) cycles; and
the one or more FEC code words comprise an FEC code word that spans at least portions of multiple TDD cycles.

20. The method of claim 16, wherein:
the transmitting comprises transmitting the plurality of OFDM symbols during downstream time windows in respective TDD cycles;
the one or more FEC code words comprise a plurality of FEC code words;
the plurality of FEC code words comprises an initial FEC code word following the start-of-frame delimiter on the PHY control channel; and
the initial FEC code word specifies a TDD cycle structure.

21. The method of claim 16, wherein:
the PHY frame comprises a first TDD cycle and a second TDD cycle that follows the first TDD cycle;
the one or more FEC code words comprise a plurality of FEC code words;
the plurality of FEC code words comprises a first group of FEC code words on the PHY control channel in the first TDD cycle and a second group of FEC code words on the PHY control channel in the second TDD cycle; and
the first group comprises a respective FEC code word that specifies a TDD cycle structure.

22. A coax network unit (CNU), comprising a receiver to:
receive a plurality of orthogonal frequency-division multiplexing (OFDM) symbols;
identify a start-of-frame delimiter on a physical-layer (PHY) control channel in the plurality of OFDM symbols, the PHY control channel comprising a plurality of contiguous subcarriers; and
decode one or more forward error correction (FEC) code words that follow the start-of-frame delimiter on the PHY control channel, the one or more FEC code words providing PHY control data that comprise information specifying a structure of a PHY frame that includes the plurality of OFDM symbols.

23. The CNU of claim 22, wherein the plurality of contiguous subcarriers for the PHY control channel is at the center of a band.

24. The CNU of claim 22, wherein the receiver is further to:
detect one or more pairs of continual pilot symbols in the plurality of OFDM symbols, wherein respective pairs of the one or more pairs are symmetric about the PHY control channel; and
determine a location of the PHY control channel based on locations of the respective pairs.

25. The CNU of claim 22, wherein the receiver is further to:
receive the plurality of OFDM symbols during downstream time windows in respective time-division duplexing (TDD) cycles;
detect continual pilot symbols in the plurality of OFDM symbols; and
identify the beginnings and ends of the downstream time windows based on the continual pilot symbols.

26. The CNU of claim 22, wherein:
the receiver is to receive the plurality of OFDM symbols during downstream time windows in respective TDD cycles;
the one or more FEC code words comprise a plurality of FEC code words;
the plurality of FEC code words comprises an initial FEC code word following the start-of-frame delimiter on the PHY control channel; and
the initial FEC code word specifies a TDD cycle structure.

27. The CNU of claim 22, wherein:
the PHY frame comprises a first TDD cycle and a second TDD cycle that follows the first TDD cycle;
the one or more FEC code words comprise a plurality of FEC code words;
the plurality of FEC code words comprises a first group of FEC code words on the PHY control channel in the first TDD cycle and a second group of FEC code words on the PHY control channel in the second TDD cycle; and
the first group comprises a respective FEC code word that specifies a TDD cycle structure.

28. A coax network unit (CNU), comprising:
means for receiving a plurality of orthogonal frequency-division multiplexing (OFDM) symbols;
means for identifying a start-of-frame delimiter on a physical-layer (PHY) control channel in the plurality of OFDM symbols, the PHY control channel comprising a plurality of contiguous subcarriers; and
means for decoding one or more forward error correction (FEC) code words that follow the start-of-frame delimiter on the PHY control channel, the one or more FEC code words providing PHY control data that comprise information specifying a structure of a PHY frame that includes the plurality of OFDM symbols.

29. The CNU of claim 28, wherein the plurality of contiguous subcarriers for the PHY control channel is at the center of a band.

30. The CNU of claim 28, further comprising means for determining a location of the PHY control channel based on locations of one or more pairs of continual pilot symbols in the plurality of OFDM symbols, wherein respective pairs of the one or more pairs are symmetric about the PHY control channel.
